(19) United States
(12) Patent Application Publication
(10) Pub. No.: US 2009/0000491 A1
(43) Pub. Date: Jan. 1, 2009

(54) DEVICE FOR COOKING FOODSTUFFS

(75) Inventor: Wei CHEN, Xiamen (CN)

Correspondence Address: KENING LI;PINSENT MASONS, c/o BAKER DONELSON BEARMAN CALDWELL& BERKOWITZ, PC, 555 ELEVENTH STREET, NW, SIXTH FLOOR, WASHINGTON, DC, 20004, US

(73) Assignee: TSANN KUEN (CHINA) ENTERPRISE CO., LTD., Xiamen (CN)

(21) Appl. No.: 12/123,002

(22) Filed: May 19, 2008

(30) Foreign Application Priority Data
May 17, 2007 (CN) 200710008985.2

(51) Int. Cl. A47J 37/06

(52) U.S. Cl. 99/379

(57) ABSTRACT

The present invention discloses a device for cooking foodstuffs, comprising an upper cooking plate unit, a lower cooking plate unit and a hinge unit; the hinge unit is connected between the lifting rod base and the lifting rod for controlling relative positions between the upper cooking plate unit and the lower cooking plate unit; the hinge unit comprises a push button whose tail end is installed through a connecting-through hole, an elasticity piece and a push piece.

### FIELD OF THE INVENTION

The present invention relates to a device for cooking foodstuffs, more particularly to a cooking device which has two cooking plates that can be aligned with each other and have different angles between them in an unfolded state.

### RELATED ART

Traditional cooking device comprises an upper cooking plate unit and a lower cooking plate unit. The upper cooking plate unit is hinged to the lower cooking plate unit. The upper cooking plate unit comprises an upper base and an upper cooking plate that is installed on the upper base, and the upper cooking plate has an upper cooking surface. The lower cooking plate unit comprises a lower base and a lower cooking plate that is installed on the lower base, and the lower cooking plate has a lower cooking surface. The food is placed on the lower cooking surface, and the upper cooking plate unit is folded on the lower cooking plate unit, and is cooked between the upper cooking surface and the lower cooking surface.

The upper cooking plate unit of the traditional cooking device can only be rotated to a fixed angle that is usually slightly larger than 90 degrees relative to the lower cooking plate for conveniently placing and removing food. Although the traditional cooking device can cook food, it cannot adjust angles between the upper cooking plate unit and the lower cooking plate unit. Therefore, it cannot satisfy different demands of different unfolded angles between the upper cooking plate unit and the lower cooking plate unit. Moreover, consumers cannot cook the food on the lower cooking surface without contact with the upper cooking surface, so it cannot meet certain needs of users.

### SUMMARY OF THE INVENTION

The present invention provides a cooking device, whose object is to overcome the disadvantage of the traditional cooking device that cannot adjust the angles between the upper cooking surface and the lower cooking surface, and cannot meet actual needs of consumers.

Such object of the present invention will become apparent in the ensuing description:

A cooking device comprises an upper cooking plate unit, a lower cooking plate unit and a hinge unit. The upper cooking plate unit comprises an upper base and an upper cooking plate is installed on the upper base, the upper base has at least a lifting rod having a connecting-through hole, and inner circumferential surface of the connecting-through hole has at least an inner concave block. The lower cooking plate unit comprises a lower base and a lower cooking plate is installed on said lower base, the lower cooking plate unit is hinged to the upper cooking plate unit, and the lower base has lifting rod base. The hinge unit is connected between the lifting rod base and the lifting rod for controlling relative positions between the upper cooking plate unit and the lower cooking plate unit; the hinge unit comprises at least a push button whose tail end is installed through the connecting-through hole, an elasticity piece and a push piece. The elasticity piece invaginates the push button for bunting the push button from interior to exterior. The push piece has a transverse protrusion block, and the push piece and the lifting rod base form a rotatable connection with a limited rotation angle; head end of the push piece is connected to the tail end of the push button; in normal condition, at elasticity of the elasticity piece, the transverse protrusion block is inserted into the transverse inner concave block of the lifting rod to make the push piece and the lifting rod to form a synchronous rotational movement; pressing the push button to make the push button bunt the push piece to back off so as to make the transverse protrusion block of the push piece get away from the transverse inner concave block of the lifting rod.

According to a preferred embodiment, one end of the elasticity piece bunts the push button and the other end bunts the lifting rod base.

According to a preferred embodiment, an inner side of the lifting rod leans against an outer side of the lifting rod base.

According to a preferred embodiment, one end of the lifting rod has a stairs-shaped connecting-through hole that has a big exterior and a small interior; the small opening of the connecting-through hole has a transverse inner concave block; one side of the transverse inner concave block of the lifting rod is connected to the inner circumferential surface of the lifting rod and the other side is closed.

According to a preferred embodiment, the push button is stairs-shaped to match with the connecting-through hole; a small pole of the push button is matched with the small opening of the connecting-through hole, and a big pole of the push button is matched with the big opening of the connecting-through hole.

According to a preferred embodiment, transverse length of the transverse inner concave block is not bigger than maximal transverse moving distance of the push button.

According to a preferred embodiment, the push button is T-shaped.

According to a preferred embodiment, an outer surface of the lifting rod base is caved inwardly to form a holding hole; back part of the push piece is rotatably connected to the holding hole, and the holding hole has a position-limiting block for limiting the limited rotation angle between the push piece and the lifting rod base.

According to a preferred embodiment, the tail end of the push piece is assembled inside the annular holding hole of the lifting rod base 111 rotatably; the transverse block and the position-limiting block of the holding hole forms a rotatable connection with a limited rotation angle.

According to a preferred embodiment, the limited rotation angle is less than or equal to 180°.

According to a preferred embodiment, the limited rotation angles can be 0 degree, 105 degrees or 180 degrees.

As shown in above-mentioned descriptions compared with the existing technology, the present invention has advantages as follows: the cooking device of the present invention has a hinge unit that can control relative position of the upper cooking plate unit and the lower cooking plate unit, to make the two cooking plates form different angles, as a result to solve the problem that the conventional cooking devices can not satisfy using demands of consumers. The hinge unit of the cooking device of the present invention has a push button, an elasticity piece and a push piece, which cooperates with the lifting rod and the lifting rod base to achieve the objective of controlling relative position of the upper cooking plate unit and the lower cooking plate unit, which has a simple structure, is assembled easily and has a lower production cost. If the inner circumferential surface of the connecting-through hole of the present invention has several inner concave blocks hollowly, it can adjust the different angles between the upper cooking plate unit and the lower cooking plate unit by inserting the transverse protrusion block of the push piece into different transverse inner concave blocks of the lifting rod.

### BRIEF DESCRIPTION OF THE DRAWINGS

Following are further description according to drawings and embodiments.

FIG. 1 is a perspective view of a cooking device that is in close state according to a preferred embodiment.

FIG. 2 is a perspective view of the cooking device that is in a fully unfolded state with unfolding the upper cooking plate unit according to the preferred embodiment.

FIG. 3 is a partial exploded view of the cooking device according to the preferred embodiment.

FIG. 4 is a sectional view of the cooking device that is in a half unfolded state with unfolding the upper cooking plate unit according to the preferred embodiment.

FIG. 5 is a sectional view of the cooking device that is in a fully unfolded state with unfolding the upper cooking plate unit according to the preferred embodiment.

### DETAILED DESCRIPTION OF THE PREFERRED EMBODIMENTS

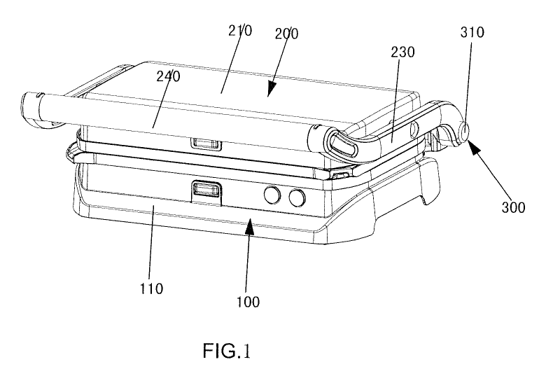

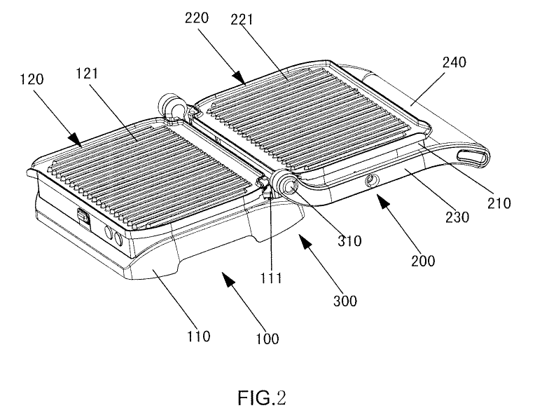

Referring to FIGS. 1 and 2, wherein FIG. 1 is a perspective view of a cooking device that is in the closed state according to a preferred embodiment and FIG. 2 is a perspective view of the cooking device that is in a fully unfolded state with unfolding the upper cooking plate unit according to the preferred embodiment. The cooking device that is in a half unfolded state is explained below. The cooking device comprises a lower cooking plate unit 100, an upper cooking plate unit 200 and a hinge unit 300.

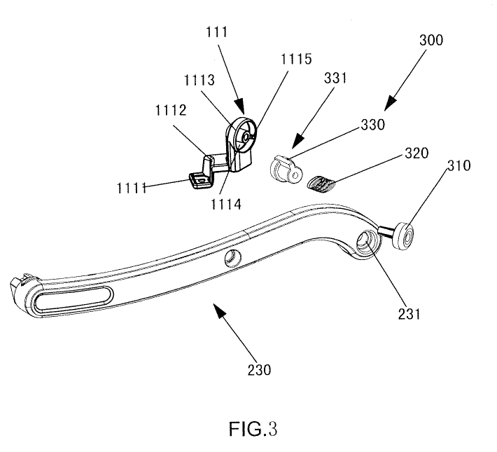

Referring to FIGS. 1 and 2, the lower cooking plate unit 100 comprises a lower base 110 and a lower cooking plate 120 that is installed on the lower base 110, wherein the lower cooking plate 120 has a cooking surface 121. Both a left backside and a right backside of the lower base 110 have lifting rod bases 111 fixed thereon respectively. Referring to FIG. 3, it is a partial exploded view of the cooking device according to the preferred embodiment. The lifting rod base 111 comprises a fastening part 1111, a middle curved part 1112 and a connecting part 1113. The fastening part 1111 and the middle curved part 1112 and the connecting part 1113 are integrally formed in one piece. The fastening part 1111 is fixed to a left end surface and a right end surface of a backside of the lower base 110. The middle curved part 1112 is disposed between the fastening part 1111 and the connecting part 1113. An outer surface of the connecting part 1113 is dented inwardly to form an annular holding hole 1114, and a position-limiting block 1115 is disposed in the holding hole 1114.

Referring to FIGS. 1 and 2, the upper cooking plate unit 200 comprises an upper base 210, an upper cooking plate 220 that is installed on the upper base 210, two lifting rods 230 and a fastening rod 240, wherein the upper cooking plate 220 has an upper cooking surface 221. The two lifting rods 230 are respectively fixed to a left side and a right side of the upper base 210. Both a first end and a second end of the lifting rods 230 extend outside of the upper base 210, and the fastening rod 240 is fixed to the first ends of the two lifting rods 230. Referring to FIG. 3, the second end of the lifting rod 230 has a connecting-through hole 231 that has a big exterior and a small interior, and a transverse inner concave block 2311 is disposed in the connecting-through hole 231.

Referring to FIGS. 1 and 2, inner sides of above-mentioned two lifting rods 230 respectively lean against outer side of the lifting rod base 111 to form a mutual rotational connection mode, and wherein a hinge unit 300 is disposed between one lifting rod 230 and one corresponding lifting rod base 111. Referring to FIG. 3, the hinge unit 300 comprises a push button 310, an elasticity piece 320 and a push piece 330.

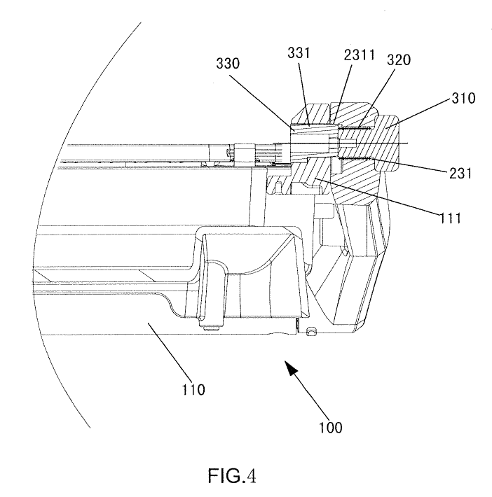

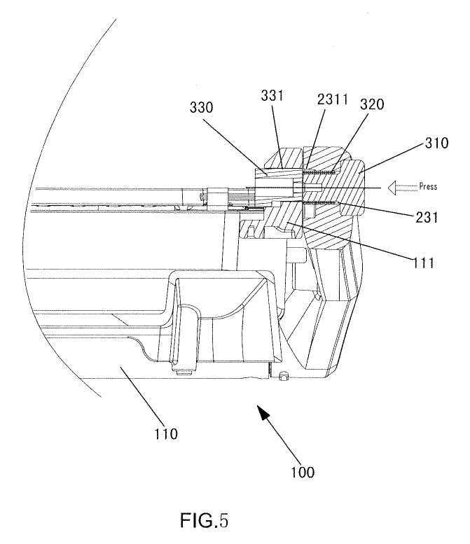

Referring to FIGS. 3, 4, 5, wherein FIG. 4 is a sectional view of the cooking device that is in a half unfolded state with unfolding the upper cooking plate unit 200 according to the preferred embodiment, and FIG. 5 is a sectional view of the cooking device that is in a fully unfolded state with unfolding the upper cooking plate unit 200 according to the preferred embodiment. The push button 310 is stairs-shaped and matched with the connecting-through hole 231, wherein the push button 310 is inserted into the connecting-through hole 231 from exterior to interior, and a small pole of the push button 310 is matched with a small opening of the connecting-through hole 231, and a big pole of the push button 310 is matched with a big opening of the connecting-through hole 231.

A tail end of the push piece 330 is annular, and the push piece 330 protrudes upwards to form a transverse protrusion block 331. A head of the push piece 330 is fixed to an end of the small pole of the push button 310. The tail end of the push piece 330 is assembled inside the annular holding hole 1114 of the lifting rod base 111 rotatably. The transverse protrusion block 331 and the position-limiting block 1115 of the holding hole 1114 forms a rotatable connection with a limited rotation angle that can be 105 degrees.

The elasticity piece 320 invaginates the small pole of the push button 310, wherein one end of the elasticity piece 320 leans against an annular surface of the big pole of the push button 310 and the other end leans against the lifting rod base 111. The push button 310 is pushed by elasticity of the elasticity piece 320 to make its end come out of an outer surface of the lifting rod 230. The transverse protrusion block 331 is inserted into the transverse inner concave block 2311 of the lifting rod 230 to make the push piece 330 and the lifting rod 230 form a synchronous rotational movement. One end of the transverse inner concave block 2311 of the lifting rod 230 is connected to inner circumferential surface of the lifting rod 230 and the other end is close.

Transverse length of the transverse inner concave block 2311 is equal to maximal transverse moving distance of the push button 310 to make the end surface of the push piece 330 be level with cooperating side of the lifting rod base 111 when the push button 310 is fully pressed.

When the cooking device is in close state, the transverse protrusion block 331 is inserted into the transverse inner concave block 2311 of the lifting rod 230 to make the push piece 330 and the lifting rod 230 form a synchronous rotational movement under the action of elasticity of the elasticity piece 320. When users lift the fastening rod 240, the lifting rod 230 and the push piece 330 will swing relative to the lifting rod base 111 and the lower base 110. When the transverse protrusion block 331 of the push piece 330 swings to contact the position-limiting block 1115 of the lifting rod base 111, the position-limiting block 1115 will stop rotating the push piece 330, namely the push piece 330 is rotated to its limited rotation angle of 105 degrees. The lower cooking plate unit 100 has an angle of 105 degrees relative to the upper cooking plate unit 200, which is half unfolded state for cooking food.

When users press push button 310 to overcome elasticity of elasticity piece 320, the push button 310 pushes the push piece 330 move backwardly until the first end surface of the push piece 330 is level with cooperating side of the lifting rod base 111, to make the transverse protrusion block 331 of the push piece 330 get away from the transverse inner concave block 2311 of the lifting rod 230, and to make the push piece 330 and the lifting rod 320 form a free rotation movement, namely the lifting rod 120 can freely swing relative to the push piece 330, the lifting rod base 111 and the lower base 110.

The upper cooking plate unit 200 can be rotated sequentially until it has a angle of 180 degrees relative to the lower cooking plate 100, which is fully folded state for cooking food as an iron plate used for teppanyaki grill.

In closing the cooking device, rotating the upper cooking plate unit 200 to 105 degrees relative to the lower cooking plate 100, the transverse protrusion block 331 will be inserted into the transverse inner concave block 2311 of the lifting rod 230 under the action of the elasticity of elasticity piece 320 so as to make the push piece 330 and the lifting rod 230 form a synchronous rotational connection.

In another embodiment, a small opening of the connecting-through hole 231 is concaved inwardly to form several transverse inner concave blocks 2311. When users press push button 310 to overcome elasticity of elasticity piece 320, the push button 310 pushes the push piece 330 move backwards until the first end surface of the push piece 330 is level with cooperating side of the lifting rod base 111, to make the transverse protrusion block 331 of the push piece 330 get away from the transverse inner concave blocks 2311 of the lifting rod 230, and to make the push piece 330 and the lifting rod 230 form a free connection, namely the lifting rod 230 can freely swing relative to the push piece 330, the lifting rod 111 and the lower base 110. Users can rotate the upper cooking plate unit 200 sequentially until the transverse protrusion block 331 is inserted into another transverse inner concave block 2311 of the lifting rod 230. This mode can adjust the different angles between the upper cooking plate unit 200 and the lower cooking plate unit 100 by inserting the transverse protrusion block 331 of the push piece 330 into different transverse inner concave blocks 2311 of the lifting rod 230.

According to above preferred embodiments, the cooking device of the present invention has a hinge unit that can control relative positions of the upper cooking plate unit and the lower cooking plate unit, to make the two cooking plates form different angles, as a result to solve the problem that the conventional cooking devices cannot meet above-mentioned needs of consumers. The hinge unit of the cooking device of the present invention has a push button, an elasticity piece and a push piece, which cooperates with the lifting rod and the lifting rod base to achieve the objective of controlling relative positions of the upper cooking plate unit and the lower cooking plate unit, which has a simple structure, is assembled easily and has a lower production cost.

The foregoing description of the exemplary embodiment of the invention has been presented for the purposes of illustration and description. It is not intended to be exhaustive or to limit the invention to the precise form disclosed. Many modifications and variations are possible in light of the above teaching. All changes that come within the meaning and range of equivalency of the claims are to be embraced within their scope.

What is claimed is:

1. A device for cooking foodstuffs, comprising:
an upper cooking plate unit comprising an upper base and an upper cooking plate installed on said upper base, wherein said upper base at least has a lifting rod having a connecting-through hole, and an inner circumferential surface of said connecting-through hole at least has a transverse inner concave block; a lower cooking plate unit comprising a lower base and a lower cooking plate installed on said lower base, wherein said lower cooking plate unit is hinged to said upper cooking plate unit, and said lower base has a lifting rod base; and
a hinge unit connected between said lifting rod base and said lifting rod for controlling a relative position between said upper cooking plate unit and said lower cooking plate unit, wherein said hinge unit comprises:
a push button whose tail end is installed through said connecting-through hole;
an elasticity piece invaginating said push button for bunting said push button; and
a push piece having a transverse protrusion block, wherein said push piece and said lifting rod base forms a rotatable connection with a limited rotation angle; a head end of said push piece is connected to said tail end of said push button; wherein in a first condition under action of elasticity of said elasticity piece, said transverse protrusion block is inserted into said transverse inner concave block of said lifting rod to make said push piece and said lifting rod to form a rotational movement; and in a second condition when said push button is pressed against said elasticity piece, said push button can bunt said push piece to back off so as to make said transverse protrusion block of said push piece get away from said transverse inner concave block of said lifting rod.

2. The device according to claim 1, wherein one end of said elasticity piece bunts said push button and the other end of said elasticity piece bunts said lifting rod base.

3. The device according to claim 2, wherein an inner side of said lifting rod leans against an outer side of said lifting rod base.

4. The device according to claim 3, wherein one end of said lifting rod has a stairs-shaped connecting-through hole that has a big opening on the exterior and a small opening relative to said big opening in the interior; said small opening of said connecting-through hole has a transverse inner concave block.

5. The device according to claim 4, wherein said push button is stairs-shaped to match with said connecting-through hole; a small pole of said push button is matched with said small opening of said connecting-through hole, and a big pole of said push button is matched with said big opening of said connecting-through hole.

6. The device according to claim 3, wherein transverse length of said transverse inner concave block is less than maximal transverse moving distance of said push button.

7. The device according to claim 3, wherein transverse length of said transverse inner concave block is equal to maximal transverse moving distance of said push button.

8. The device according to claim 4, wherein a cross-section of said push button is T-shaped.

9. The device according to claim 1, wherein an outer surface of said lifting rod base is caved inwardly to form a holding hole; a back part of said push piece is connected to said holding hole rotatably, and said holding hole has a position-limiting block used for limiting said limited rotation angle between said push piece and said lifting rod base.

10. The device according to claim 9, wherein said tail end of said push piece is assembled inside said holding hole of said lifting rod base rotatably; said transverse protrusion block and said position-limiting block of said holding hole form a rotatable connection with said limited rotation angle.

11. The device according to claim 10, wherein said limited rotation angle is less than 180 degrees.

12. The device according to claim 10, wherein said limited rotation angle is equal to 180 degrees.

13. The device according to claim 10, wherein said limited rotation angle can be 0 degree.

14. The device according to claim 10, wherein said limited rotation angle is 105 degrees.

15. The device according to claim 10, wherein said limited rotation angle is 180 degrees.

16. The device according to claim 1, wherein said limited rotation angle is less than 180 degrees.

17. The device according to claim 1, wherein said limited rotation angle is equal to 180 degrees.

18. The device according to claim 1, wherein said limited rotation angle can be 0 degree.

19. The device according to claim 1, wherein said limited rotation angle is 105 degrees.

20. The device according to claim 1, wherein said limited rotation angle is 180 degrees.

21. The device according to claim 1, wherein said rotational movement of said push piece and said lifting rod is a synchronous rotation movement.
